(19) United States
(12) Patent Application Publication
(10) Pub. No.: US 2012/0311616 A1
(43) Pub. Date: Dec. 6, 2012

(54) SPINDLE MOTOR HAVING SHAFT WITH AXIALLY UPWARDLY OPENING INSERTION GROOVE

(75) Inventors: Hyuk Joo Kim, Seoul (KR); Ta Kyoung Lee, Hwaseong (KR); Bum Cho Kim, Seoul (KR)

(73) Assignee: Samsung Electro-Mechanics Co., Ltd., Suwon (KR)

(21) Appl. No.: 13/317,929

(22) Filed: Nov. 1, 2011

(30) Foreign Application Priority Data
Jun. 3, 2011 (KR) 10-2011-0053936

(51) Int. Cl. G11B 19/20

(52) U.S. Cl. 720/696; G9B/19.027

(57) ABSTRACT

There is provided a spindle motor including a stator and a rotor, including: a shaft rotatably mounted with respect to the stator; and a rotor case coupled with the shaft and including a protruding part protruded axially downwardly from a lower portion of an inner diameter part thereof, wherein the shaft is provided with an outer wall part formed to have an insertion groove opened axially upwardly into which the protruding part is inserted so as to compensate for a reduction in adhesion due to a reduction in a thickness of the rotor case.

### CROSS-REFERENCE TO RELATED APPLICATIONS

This application claims the priority of Korean Patent Application No. 10-2011-0053936 filed on Jun. 3, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor in which a bearing clearance is formed by a shaft and a sleeve and a radial dynamic groove is provided on any one of the shaft and the sleeve.

2. Description of the Related Art

A small spindle motor used in a hard disk drive (HDD) is generally provided with a fluid dynamic pressure bearing assembly, and a lubricating fluid such as oil is filled in a bearing clearance formed between a shaft and a sleeve of the fluid dynamic pressure bearing assembly. The oil filled in the bearing clearance generates fluid dynamic pressure while being compressed, thereby rotatably supporting the shaft.

That is, the fluid dynamic pressure bearing assembly generally generates dynamic pressure through a spiral shaped groove in an axial direction and a herringbone shaped groove in a circumferential direction, thereby promoting stability in rotational driving of the motor.

Meanwhile, in accordance with the recent increase in capacity of the hard disk drive, a technical problem in which vibrations generated during driving of the spindle motor should be reduced has been generated. That is, in order to allow the recording disk driving device to be driven without an error due to the vibrations generated during the driving of the spindle motor, the demand for improvements in the performance of the fluid dynamic pressure bearing assembly included in the spindle motor has been increased.

In addition, in order to improve the performance of the fluid dynamic pressure bearing assembly, there is a need to increase an interval (that is, a length of a bearing span) between the herringbone shaped grooves to move a rotating center upwardly, thereby promoting the driving stability of the motor.

Meanwhile, the spindle motor has tended to be miniaturized and thinned as the recording disk driving device has tended to be thinned.

Therefore, in order to implement thinness, the thinness of the spindle motor may be implemented by reducing the interval between the grooves provided in the spindle motor, that is, the length of the dynamic part or/and reducing the thickness of the rotor case coupled with the shaft.

However, when the length of the dynamic part is reduced as described above, rotational characteristics may be degraded. That is, when the length of the bearing span is reduced, the rotational characteristics of the rotor may be degraded.

In addition, in order to implement thinness in the spindle motor, when the thickness of the rotor case is reduced, the contact area between the shaft and the rotor case is reduced, such that adhesion between the shaft and the rotor case becomes weakened. In this case, the rotor case may separate from the shaft due to external impacts.

### SUMMARY OF THE INVENTION

An aspect of the present invention provides a spindle motor capable of increasing adhesion between a rotor case and a shaft and increasing a span length.

According to an aspect of the present invention, there is provided a spindle motor including a stator and a rotor, the spindle motor including: a shaft rotatably mounted with respect to the stator; and a rotor case coupled with the shaft and including a protruding part protruded axially downwardly from a lower portion of an inner diameter part thereof, the shaft being provided with an outer wall part formed to have an insertion groove opened axially upwardly into which the protruding part is inserted so as to compensate for a reduction in adhesion due to a reduction in a thickness of the rotor case.

The shaft may have a top end coupled with the rotor case and a bottom end having an outer diameter larger than the top end.

An outer surface of the outer wall part may have the same outer diameter as the bottom end and a top surface of the outer wall part may contact a bottom surface of the rotor case so as to increase an area in which the bottom end of the shaft is disposed to be opposite to an inner peripheral surface of the sleeve.

The inner surface of the outer wall part may be inclinedly formed so as to increase a contact area with the protruding part.

The insertion groove may have an axial length longer than the protruding part so that an adhesive is filled in a bottom portion of the insertion groove.

The sleeve may be provided such that a top surface thereof is disposed to be lower than the top surface of the outer wall part so as to form a bearing clearance with a bottom surface of the rotor case.

A cross section of the protruding part may have a polygonal shape so as to increase adhesion between the shaft and the rotor case.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a spindle motor according to an embodiment of the present invention;

FIG. 2 is an enlarged view of part A of FIG. 1;

FIG. 3 is a partially exploded perspective view showing a shaft, a rotor case, and a sleeve according to an embodiment of the present invention;

FIG. 4 is a cross-sectional view schematically showing a spindle motor according to another embodiment of the present invention; and

FIG. 5 is an enlarged view showing part B of FIG. 4.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

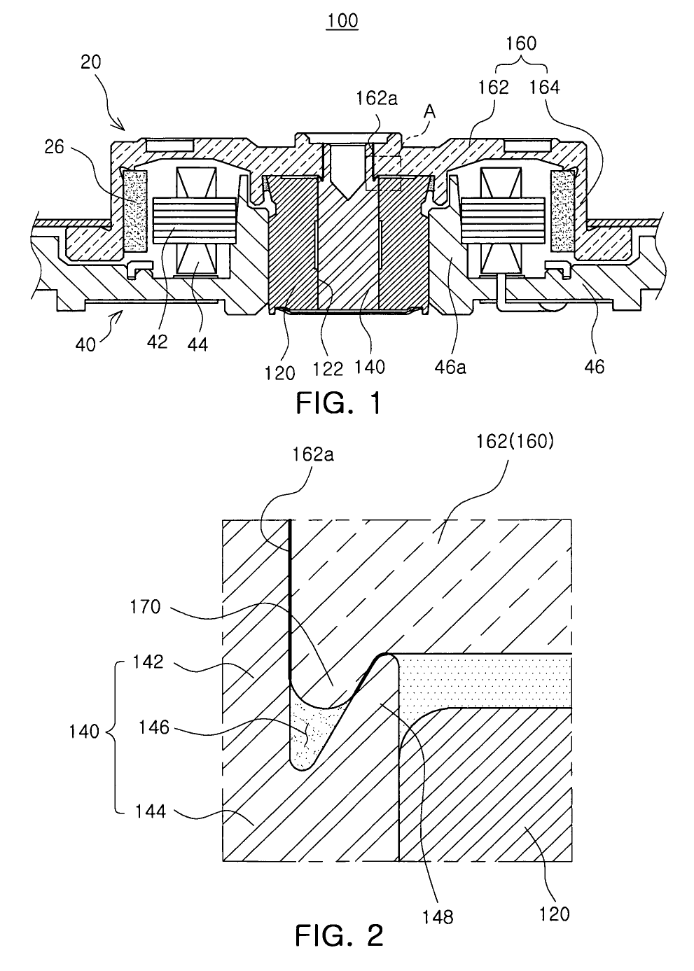

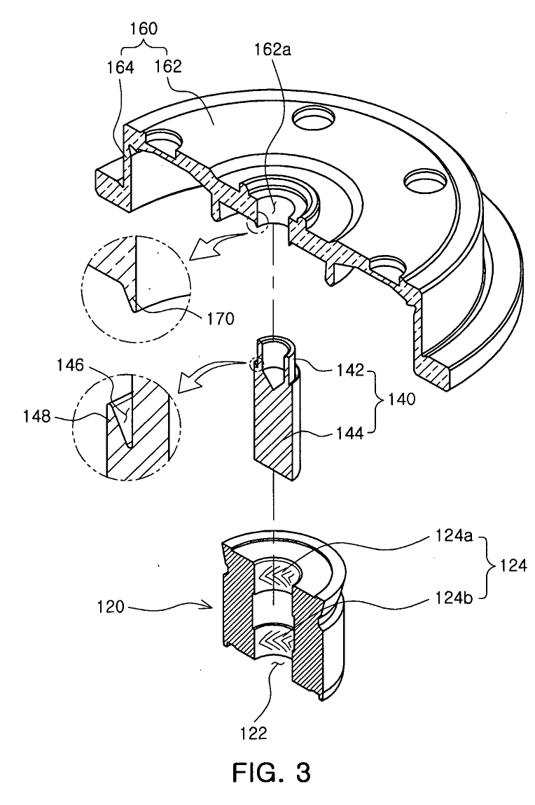

FIG. 1 is a cross-sectional view schematically showing a spindle motor according to an embodiment of the present invention, FIG. 2 is an enlarged view of part A of FIG. 1, and FIG. 3 is a partially exploded perspective view showing a shaft, a rotor case, and a sleeve according to an embodiment of the present invention.

Referring to FIGS. 1 through 3, a spindle motor 100 according to an embodiment of the present invention may include a sleeve 120, a shaft 140, and a rotor case 160.

Meanwhile, the spindle motor 100 may be a motor used in a recording disk driving device rotating a recording disk, and include a rotor 20 and a stator 40.

The rotor 20 denotes a rotating member rotating while supporting the stator 40, and may include a cup-shaped rotor case 160 in which a stator core 42 configuring a stator 40 and its corresponding magnet 26 are mounted. The annular ring-shaped magnet 26 may be a permanent magnet generating magnetic force having a constant strength by alternately magnetizing an N pole and an S pole thereof in a circumferential direction.

Further, the stator 40, which denotes all fixing members other than the rotating members, may include the stator core 120, a winding coil 44 wound around the stator core 42, a base member 46, and a sleeve 120.

Meanwhile, the magnet 26 mounted in the rotor case 160 is disposed to be opposite to an end of the stator core 42 around which the winding coil 44 is wound and the rotor 20 rotates by electromagnetic interaction between the magnet 26 and the stator core 42 around which the winding coil 44 is wound.

In other words, the rotor case 160 rotates by the electromagnetic interaction between the magnet 26 and the stator core 42 around which the winding coil 44 is wound and thus, the shaft 140, or the like, configuring the rotor 20, rotates.

The sleeve 120 is fixed to the base member 46. That is, the sleeve 120 is inserted into a sleeve housing 46a provided in the base member 46. In this case, the sleeve 120 may be fixed to the sleeve housing 46a by an adhesive.

Meanwhile, the sleeve 120 may have a cylindrical shape to have the shaft 140 inserted thereinto. In other words, the sleeve 120 may be provided with a mounting hole 122 in which the shaft 140 is mounted.

Further, when the shaft 140 is mounted in the sleeve 120, the outer surface of the shaft 140 and the inner surface of the sleeve 120 are mounted to be spaced apart by a predetermined interval, thereby forming a bearing clearance. The bearing clearance is filled with a lubricating fluid so as to form fluid dynamic pressure when the shaft 140 rotates.

Further, the inner surface of the sleeve 120 may be provided with a radial dynamic pressure groove 124 so as to generate the fluid dynamic pressure. Further, the radial dynamic pressure groove 124 may include top and bottom radial dynamic grooves 124a and 124b as shown in FIG. 3.

Meanwhile, a span length S denotes a length between an area in which the fluid dynamic pressure formed by the top radial dynamic pressure groove 122a becomes maximal, and an area in which the fluid dynamic pressure formed by the bottom dynamic pressure groove 122b becomes maximal.

The shaft 140 is rotatably mounted in the sleeve 120. Further, the shaft 140 may have a top end 142 with which the rotor case 160 is coupled and a bottom end 144 having an outer diameter larger than the top end.

Meanwhile, when the shaft 140 is mounted in the sleeve 120, the shaft 140 is mounted in the sleeve 120 so that the bottom end 144 of the shaft 140 is disposed to be opposite to an inner peripheral surface of the sleeve 120.

Further, the shaft 140 may be provided with the outer wall part 148 on which the insertion groove 146 opened axially upwardly is disposed so as to increase the span length by increasing the area disposed to be opposite to the sleeve 120.

Further, the outer surface of the outer wall part 148 has the same outer diameter as the bottom end 144 and the top surface of the outer wall part 148 contacts the bottom surface of the rotor case 160 so as to increase the area in which the bottom end 144 of the shaft 140 is disposed to be opposite to the inner peripheral surface of the sleeve 120.

A detailed description thereof will be provided below.

Meanwhile, the inner surface of the outer wall part 148 may be inclinedly formed. That is, the inner surface of the outer wall part 148 may be inclinedly formed so as to increase adhesion with the rotor case 160.

Further, the sleeve 120 may be provided such that the top surface of the sleeve 120 is disposed to be lower than the top surface of the outer wall part 148 so as to form the bearing clearance with the bottom surface of the rotor case 160.

The rotor case 160 may be coupled with the shaft 140 and may include the protruding part 170 protruded axially downwardly from a lower portion of the inner diameter part thereof.

Meanwhile, the rotor case 160 may include a body 162 in which a mounting hole 162a into which the top end 142 of the shaft 140 is inserted, and a magnet mounting part 164 extendedly formed from an edge of the body 162 and having the magnet 26 mounted therein.

Further, when the protruding part 170 is extendedly formed axially downwardly from the bottom surface of the body 162 to couple the rotor case 160 with the shaft 140, the protruding part 170 is inserted into the insertion groove 146 formed on the shaft 140.

In addition, the rotor case 160 is coupled with the shaft 140 by an adhesive and/or press-fitted to the shaft 140. In this case, the rotor case 160 and the shaft 140 need to have a predetermined level of adhesion so as to prevent the rotor case 160 from separating from the shaft due to external impacts.

That is, the axial length of the inner diameter part of the body 162 forming the mounting hole 162a should have a length generating adhesion of a predetermined level or more by contacting the shaft 140.

To this end, the rotor case 160 is provided with the protruding part 170, such that the contact area of the shaft 140 and the rotor case 160 may be increased by the protruding part 170 and thus, the adhesion between the shaft 140 and the rotor case 160 may be more increased.

In addition, the insertion groove 146 formed by the outer wall part 148 of the shaft 140 is filled with an adhesive so as to increase adhesion between the rotor case 160 and the shaft 140.

In addition, the insertion groove 146 may have an axial length longer than that of the protruding part 170 so that the adhesive may be filled in the insertion groove 146. Further, the protruding part 170 may have a shape corresponding to a shape of the insertion groove 146. That is, a cross section of the protruding part 170 may have a triangular shape.

That is, the rotor case 160 is coupled with the shaft 140 so that the protruding part 170 is inserted into the insertion groove 146, such that the adhesion between the rotor case 160 and the shaft 140 may be increased.

Therefore, the thickness of the body 162 of the rotor case 160 may be reduced and thus, the axial length of the sleeve 120 may be increased.

In other words, the adhesion between the rotor case 160 and the shaft 140 may be increased by the protruding part 170, such that the axial length of the sleeve 120 may be increased while reducing the thickness of the body 162 of the rotor case 160.

As a result, the area in which the inner surface of the sleeve 120 is disposed to be opposite to the bottom end 144 of the shaft 140 may be increased and thus, the span length may be increased.

Further, the axial length of the sleeve 120 may be increased while reducing the thickness of the body 162 of the rotor case 160 through the protruding part 170. Therefore, the adhesion between the rotor case 160 and the shaft 140 may be obtained to correspond that of the case in which the thickness of the body 162 of the rotor case 160 is not reduced.

As described above, the contact area between the rotor case 160 and the shaft 140 is increased by inserting the protruding part 170 into the insertion groove 146, such that the adhesion between the rotor case 160 and the shaft 140, that is, unmating force, may be increased.

That is, when external impacts are applied, the rotor case 160 may be prevented from separating from the shaft 140.

In addition, as compared with the case in which the protruding part 170 is not provided, the area in which the outer surface of the shaft 140 is disposed to be opposite to the inner surface of the sleeve 120 is increased while maintaining the adhesion between the rotor case 160 and the shaft 140 and thus, the span length may be increased.

As a result, the rotating characteristics of the spindle motor 100 may be improved by increasing the span length.

Hereinafter, a spindle motor according to another embodiment of the present invention will be described with reference to the accompanying drawings.

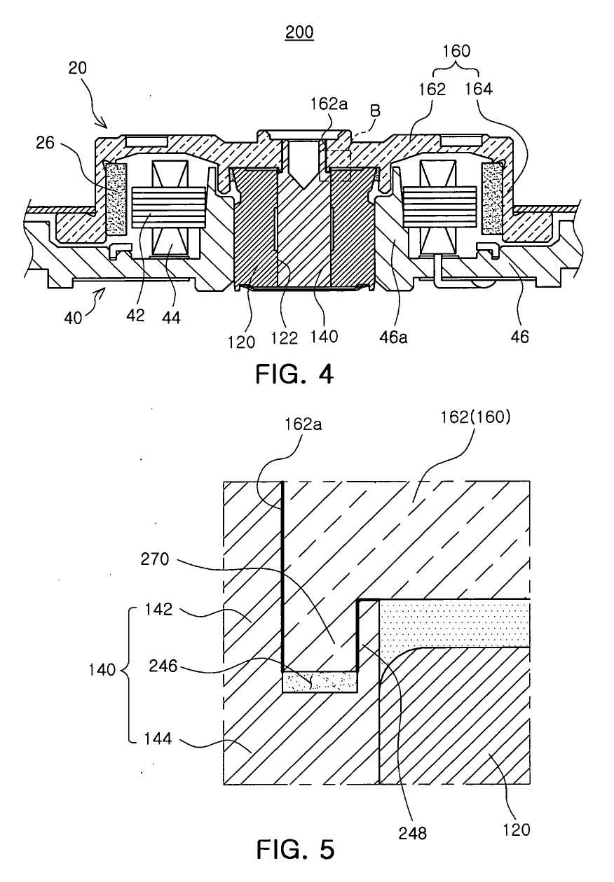

FIG. 4 is a cross-sectional view schematically showing a spindle motor according to another embodiment of the present invention, and FIG. 5 is an enlarged view showing part B of FIG. 4.

Referring to FIGS. 4 and 5, a spindle motor 200 according to another embodiment of the present invention may include a sleeve 220, a shaft 240, and a rotor case 260.

Meanwhile, the spindle motor 100 according to the embodiment of the present invention has the same configuration as the spindle motor 200 according to another embodiment of the present invention other than a protruding part 270 and an outer wall part 248 provided in the spindle motor 200 according to another embodiment of the present invention.

Therefore, only the protruding part 270 and the outer wall part 248 will be described below and the description of other components will refer to the above description and therefore, the detailed description thereof will be omitted herein.

The protruding part 270 has a shape corresponding to the shape of the insertion groove 246 formed by the outer wall part 248. Further, the cross section of the protruding part 270 may have a polygonal shape so as to have an increased contact area with the shaft 240, that is, the adhesive filled in the insertion groove 246.

That is, the shape of the cross section of the protruding part 270 may have a quadrangular shape. Therefore, the adhesion between the shaft 240 and the rotor case 260 may be more increased by the protruding part 270.

As set forth above, according to the embodiments of the present invention, adhesion between the rotor case and the shaft may be increased through the rotor case including the shaft including the outer wall part formed to have the insertion groove and the protruding part inserted into the insertion groove.

In addition, according to the embodiments of the present invention, adhesion between the rotor case and the shaft may be increased to reduce the thickness of the rotor case and increase the axial length of the sleeve, thereby increasing span length.

While the present invention has been shown and described in connection with the embodiments, it will be apparent to those skilled in the art that modifications and variations can be made without departing from the spirit and scope of the invention as defined by the appended claims.

1. A spindle motor including a stator and a rotor, comprising:
a shaft rotatably mounted with respect to the stator; and
a rotor case coupled with the shaft and including a protruding part protruded axially downwardly from a lower portion of an inner diameter part thereof,
the shaft being provided with an outer wall part formed to have an insertion groove opened axially upwardly into which the protruding part is inserted so as to compensate for a reduction in adhesion due to a reduction in a thickness of the rotor case.

2. The spindle motor of claim 1, wherein the shaft has a top end coupled with the rotor case and a bottom end having an outer diameter larger than the top end.

3. The spindle motor of claim 2, wherein an outer surface of the outer wall part has the same outer diameter as the bottom end and a top surface of the outer wall part contacts a bottom surface of the rotor case so as to increase an area in which the bottom end of the shaft is disposed to be opposite to an inner peripheral surface of a sleeve.

4. The spindle motor of claim 2, wherein an inner surface of the outer wall part is inclinedly formed so as to increase a contact area with the protruding part.

5. The spindle motor of claim 1, wherein the insertion groove has an axial length longer than the protruding part so that an adhesive is filled in a bottom portion of the insertion groove.

6. The spindle motor of claim 1, wherein a sleeve is provided such that a top surface thereof is disposed to be lower than a top surface of the outer wall part so as to form a bearing clearance with a bottom surface of the rotor case.

7. The spindle motor of claim 1, wherein a cross section of the protruding part has a polygonal shape so as to increase adhesion between the shaft and the rotor case.
